(19) United States
(12) Patent Application Publication
(10) Pub. No.: US 2017/0225270 A1
(43) Pub. Date: Aug. 10, 2017

(54) METHOD FOR PRODUCING THROUGH-HOLES IN A WALL OF A COMPONENT, BY MEANS OF LASER RADIATION

(71) Applicant: SIEMENS AKTIENGESELLSCHAFT, MÜNCHEN (DE)

(72) Inventors: THOMAS BECK, PANKETAL (DE); GEORG BOSTANJOGLO, BERLIN (DE); JENS DIETRICH, FALKENSEE (DE); OLIVER KATZURKE, BERLIN (DE); MARCEL KRÜGERKE, WANDLITZ (DE); JAN MÜNZER, BERLIN (DE); SILKE SETTEGAST, BERLIN (DE)

(21) Appl. No.: 15/514,657

(22) PCT Filed: Oct. 1, 2015
(86) PCT No.: PCT/EP2015/072664

§ 371 Date: Mar. 27, 2017

(30) Foreign Application Priority Data
Oct. 9, 2014 (DE) 10 2014 220 526.3

(51) Int. Cl. B23K 26/382

(52) U.S. Cl. CPC B23K 26/382; B23K 2201/001

(57) ABSTRACT

A method for producing through-holes in a wall of a component, by laser radiation is provided, that includes a wall delimiting a cavity in which a protection agent is provided that can be liquefied when heated. According to the method, through-holes are successively produced in the wall of the component in a plurality of defined points, two directly subsequent through-holes being produced such that a through-hole is produced in a predetermined point and the next through-hole is produced in an additional point which is further away from the predetermined point than at least two, in particular three or more omitted points that are closer to the predetermined point, and/or are produced such that a through-hole is produced in a predetermined point and the next through-hole is produced an additional point.

### CROSS-REFERENCE TO RELATED APPLICATIONS

This application claims priority to PCT Application No. PCT/EP2015/072664, having a filing date of Oct. 1, 2015, based off of DE Application No. 10 2014 220526.3 having a filing date of Oct. 9, 2014, the entire contents both of which are hereby incorporated by reference.

### FIELD OF TECHNOLOGY

The following relates to a method for producing through-holes in a wall of a component by means of laser radiation, which wall delimits a cavity in which is provided a protective agent which can liquefy under heat, in which method through-holes are introduced into the wall of the component consecutively at a multiplicity of defined drilling positions.

### BACKGROUND

There are various fields of application in which components are used and which are to be provided with through-holes of any desired shape. The components can for example be turbine components, such as gas turbine blades. The through-holes can serve for example as cooling openings.

From the known art it is known to create through-holes in a wall of a component by material being removed at predetermined drilling points on the component by a laser beam. If a through-hole is produced by laser radiation in a wall of a component which delimits a cavity in the component, then there is the problem that the laser beam, after drilling through the wall to be machined, enters the cavity and impinges upon a further wall of the component which delimits the cavity on the rear side with regard to laser beam drilling direction. As a consequence of this, undesirable damage to the rear-side wall can be caused.

This problem is countered in the known art inter alia by a protective element being introduced into the cavity in the component. A method is gathered from WO 2004/087364, for example, in which a spherical protective element is arranged in the cavity in such a way that after the laser beam has broken through the front-side wall of the component the laser beam impinges upon the protective element in the cavity. The protective element then absorbs the laser beam and the effect of the rear-side wall of the component being damaged is prevented.

This procedure for protection of components with cavities has proved to be successful. There is the problem, however, that the protective element can only be used if the cavity has at least one opening through which the protective element can be inserted into this. Such protective elements can consequently only be used if machining is carried out at easily accessible component positions, especially if the cavity in the component is easily accessible.

Therefore, further methods have been developed in order to also protect the wall, which delimits the cavity on the rear side, in components with inaccessible cavities or cavities which are difficult to access, especially almost completely closed or complexly shaped cavities, when creating through-holes by laser radiation. Therefore, it is known from the known art for example to use a protective agent which under heat liquefies and is then poured, injected or sprayed into the cavity. In the liquid state, a protective agent can be introduced in the aforesaid ways into cavities which are difficult to access. The protective agent which is introduced in the cavity hardens at ambient temperature. During the drilling process, laser radiation entering the cavity can then be absorbed by means of the protective agent which is provided in this and the wall which delimits the cavity on the rear side is protected against destruction. The cavity can be completely filled with the protective agent for protection of the wall. The protective agent is provided at least in the region of the cavity in which the through-holes are to be produced. After the finishing of the through-holes, the protective agent can be liquefied again by renewed heating and released from the cavity.

The use of liquefiable protective agents has proved to be successful in order to protect components with cavities which are difficult to access against undesirable damage when through-holes are being created by laser radiation. However, it is deemed to be disadvantageous that for the case when a multiplicity of through-holes, for example a row of through-holes, are to be introduced into the wall of the component, the component and also the protective agent are heated as a result of the impinging laser radiation to such a high degree that the protective agent is converted into the liquid state again. In this case, there is the risk that during the machining process the undesirably liquefied protective agent runs out of the cavity again or is redistributed in this in a disadvantageous way. As a result, a reliable protection of the wall which delimits the cavity on the rear side is not always ensured.

### SUMMARY

An aspect relates to a method for producing through-holes of the aforesaid type in such a way that at all times a reliable protection of walls, which delimit a cavity in the component, is ensured.

This aspect is achieved in a method of the type referred to in the introduction by two directly consecutive through-holes being produced in a way that a through-hole is created at a predetermined drilling position and the next through-hole is created at a further drilling position which lies further away from the predetermined drilling position than at least two, especially three or more, drilling positions, which are omitted, which lie close to the predetermined drilling position, and/or two directly consecutive through-holes are produced in a way that a through-hole is created at a predetermined drilling position and the next through-hole is created at a further drilling position, wherein at least one drilling position, which is omitted, lies between the predetermined drilling position and the further drilling position, in particular two or more drilling positions, which are omitted, lie between the predetermined drilling position and the further drilling position.

The following is in other words based on the idea of introducing the through-holes in a defined sequence, which deviates from the known art, especially by a defined method strategy, when producing a multiplicity of through-holes in the wall of a component with a cavity in which is provided a protective agent which can liquefy under heat. Specifically, after the introduction of a first through-hole at a first drilling position a move over to the drilling position which lies nearest to the first drilling position, as in the known art, is not carried out according to embodiments of the present invention. Rather, when introducing two consecutive through-holes at least two nearest drilling positions are deliberately omitted or at least one nearest drilling position is skipped and the next through-hole is introduced at a drilling position which lies further away from the first drilling position than the omitted or skipped drilling position(s).

In the case of the automated production of a multiplicity of through-holes in a wall of a component, the drilling positions, that is to say the positions at which material is to be removed by laser radiation for creating a through-hole, are already fixed before commencing with the actual drilling process so that according to embodiments of the present invention the process can be simply carried out in a specific manner within an established drilling-position pattern. The drilling positions, which according to embodiments of the invention are omitted or skipped when introducing two consecutive through-holes, have either been already provided with a through-hole at an earlier point in time or these have been returned to at a later point in time in order to then create a through-hole at these positions. It is essential that after producing a through-hole at least one drilling position, specifically at least the nearest drilling position and possibly further drilling positions, are omitted, therefore are not provided with a through-hole.

If there is a plurality of through-holes, which lie nearest to the predetermined first drilling position, that is to say a plurality of drilling positions which have the same smallest distance to the first drilling position, all these nearest drilling positions of equal distance are expediently omitted. If only one drilling position lies nearest to the first drilling position, for example just this one drilling position can be omitted or skipped and the second through-hole is introduced into a further drilling position which lies further away from the first drilling position than the one omitted drilling position.

A predetermined drilling-position pattern can for example comprise at least one row and/or at least one line of drilling positions. In this case, the process can especially be carried out according to embodiments of the invention in such a way that after introducing a through-hole at a first drilling position in the row or line the next drilling position, or the next drilling positions in the row or line, are skipped and at a second drilling position, which is correspondingly further way from the first drilling position than the skipped drilling positions, the next, that is to say the second, through-hole is produced.

If the predetermined drilling-position pattern has for example no rows and lines but an optionally configured, for example totally random, form, then after producing a first through-hole at a first drilling position, according to embodiments of the invention at least two drilling positions, which lie nearest to the first drilling position, preferably three or more drilling positions which lie nearest to the first drilling position, are especially omitted. The second of the two consecutively created through-holes is then introduced at a second drilling position which lies further away from the first drilling position than the two, three or more omitted closer lying drilling positions.

As a result of the intended skipping or omitting of nearest or close-lying drilling positions according to embodiments of the invention, the heat quantity which as a result of a plurality of directly consecutive drilling process is introduced into the component and also into the cavity and therefore into the liquefiable protective agent which is provided in this, is distributed to regions which are spaced wider apart. The energy input into the protective agent per time unit or volume unit is consequently reduced.

The protective agent, using the method according to embodiments of the invention in and around the region of a drilling position at which a through-hole has just been introduced, can first of all completely cool down again before being returned to the direct surrounding of this drilling position and the laser machining being continued there. The local heating up of the protective agent which is provided in the cavity of the component is consequently reduced. In this way, the effect of the protective agent being locally heated during the laser machining process as a result of the production of a multiplicity of holes, especially holes lying in close proximity to each other, to such a high degree that it converts into the liquid state again and can flow out of the cavity or can be disadvantageously distributed in this, is prevented.

Consequently, as a result of the introduction according to embodiments of the invention of two directly consecutive through-holes at non-adjacent drilling positions, the protective agent, when introducing each through-hole, is made available in the hardened state and in a suitable distribution in the cavity for protection of the rear-side wall. A wall of the component which delimits the cavity on the rear side is therefore reliably protected at all times against damage which can be caused by laser radiation which enters the cavity.

For protection of the wall which delimits the cavity on the rear side use can be made of any known protective agent which can be liquefied by heat and can harden again below a predetermined temperature. For example, as a protective agent a polymer in the liquid state can be introduced, especially poured or injected or sprayed, into the cavity before the through-holes are introduced. Wax can also be used as the protective agent. Between the introduction of the liquid protective agent into the cavity of the component and the commencement of the machining process for creating the through-holes, it is expedient to wait for a sufficient time until the protective agent is hardened.

Various fields of application require that through-holes are introduced in a component in a regular pattern. Such patterns can for example have a multiplicity of drilling positions, distributed in the form of a two-dimensional matrix, which comprise in each case two or more rows and two or more lines.

If the multiplicity of defined drilling positions comprises for example a plurality of rows and a plurality of lines of drilling positions, then in an advantageous development two directly consecutively introduced through-holes lie in different rows and/or different lines.

According to embodiments of the present invention, a plurality of rows and/or lines of omitted drilling positions can especially also lie between two directly consecutively introduced through-holes.

The second of the two directly consecutively produced through-holes in these embodiments is introduced specifically in a further drilling position which, starting from the predetermined drilling position, lies in a nearest row or in a row provided behind a nearest row and/or which, starting from the predetermined drilling position, lies in a nearest line or in a line provided behind a nearest line. Specifically, the further through-hole is introduced for example at a drilling position which is provided in the next row, that is to say above or below the predetermined drilling position or in the next line, that is to say to the right or left of the predetermined drilling position or else in the next row and the next line, for example below and to the right or above and to the left of the predetermined drilling position. In this case, there is basically a jump so that the second through-hole is introduced into a second drilling position which lies further away from the first drilling position than a nearest drilling position, or plurality of nearest drilling positions, which is or are deliberately omitted according to embodiments of the invention.

In a development of the method according to embodiments of the invention, it is also provided that in a predetermined pattern one or more nearest drilling positions and/or one or more nearest rows of drilling positions and/or one or more nearest lines of drilling positions are omitted in each case. It is expedient for example for the case when of the multiplicity of defined drilling positions a uniform field is covered, through-holes are created at all drilling positions by a uniform skipping of drilling positions and a later return to the skipped drilling positions.

The through-holes are preferably created according to the present method in a sequence at the drilling positions of the predetermined pattern of drilling positions, which on the one hand enables a sufficient distribution of the heat quantity and on the other hand optimizes the ranges of travel for the laser device which is used for producing the through-holes. To the person skilled in the art, it is clear that for example for a predetermined component, in which through-holes of predetermined diameter are to be created at fixed drilling positions, it is possible to calculate in detail, especially to simulate, how the heat input into the component, and particularly into the protective agent which is provided in the cavity of the component, is specifically carried out. Therefore, a calculation can be made for example of which distance at least between two directly consecutively introduced through-holes is to be observed so that the heat input does not accumulate in such a way that a local liquefaction of the protective agent occurs. If this distance is known, the through-holes can be introduced in such a way that this distance is always observed but is not covered by an unnecessarily wide extent by the laser device. Optimizations with regard to other parameters are also conceivable.

A further embodiment of the method according to the invention is also distinguished by the fact that the further drilling position lies at least 1.5 times, especially at least two times and preferably at least three times or at least five times further away from the predetermined drilling position than that omitted drilling position which lies nearest to the predetermined drilling position. In this case, after a first through-hole has been produced at a first drilling position, for the second through-hole a drilling position is selected of which the distance is a multiple of, especially more than 1.5 times, two times, three times or five times, the distance which lies between the first drilling position and that drilling position, which has been omitted, lying nearest to this. If the omitted or skipped drilling position, which lies nearest to the first drilling position, for example 8 mm away from this, then the second through-hole is introduced according to this embodiment at a second drilling position which is more than 12 mm, especially more than 16 mm, more than 24 mm or more than 40 mm away from the first drilling position. There can also be a plurality of drilling positions which have the same minimum distance to the predetermined drilling position, that is to say a plurality of nearest drilling positions, wherein a jump is then made in a similar manner to a drilling position which lies at a distance from the predetermined drilling position, which distance corresponds to a multiple of the distance which this multiplicity of nearest drilling positions have to the predetermined drilling position in each case.

### BRIEF DESCRIPTION

Some of the embodiments will be described in detail, with reference to the following figures, wherein like designations denote like members, wherein:

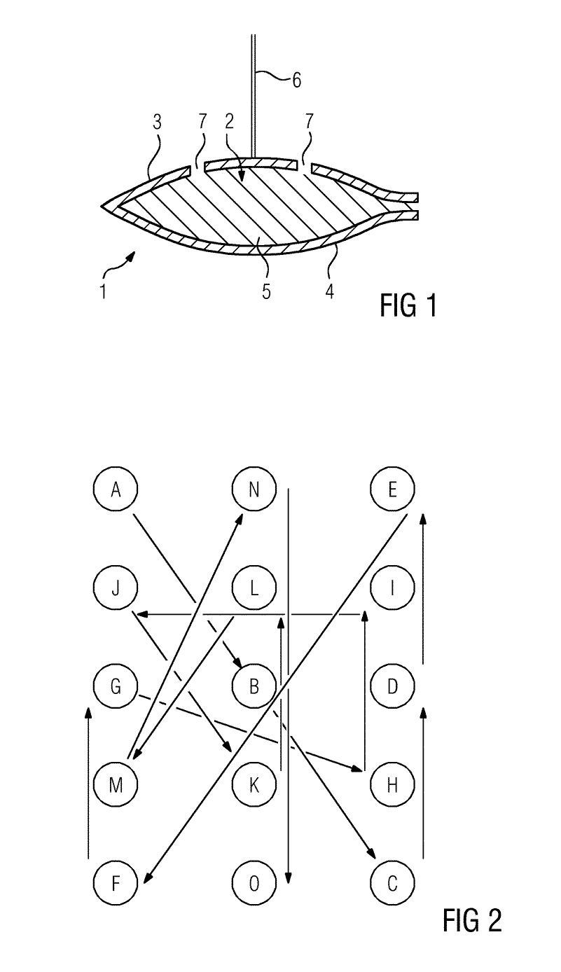

FIG. 1 shows in a schematized sectional view a component with an almost completely closed cavity; and

FIG. 2 shows a top view of a drilling-position pattern, according to which through-holes are to be created in the upper wall of the component which is shown in FIG. 1.

FIG. 1 shows in a schematized sectional view a component 1 with a cavity 2 which is difficult to access. The cavity 2 is delimited by an upper wall 3 and a lower wall 4 of the component 1. The cavity 2 is almost completely closed off by the upper wall 3 and the lower wall 4. Only in the end region of the component 1 pointing to the right in FIG. 1 is the cavity 2 accessible via a narrow opening.

The cavity 2 of the component 1 which is difficult to access is filled with a protective agent 5, specifically a polymer, which can liquefy under heat. For introducing the protective agent 5 into the cavity 2, this has first of all been converted into the liquid state under heat and then poured into the cavity 2 via the opening in the end region of the component 1 pointing to the right in FIG. 1. There would then be a predetermined waiting time which the protective agent 5 requires in order to completely harden at the surrounding temperature.

By a laser beam 6, which is shown schematically in FIG. 1, through-holes 7 are to be introduced into the upper wall 3 of the component 1 at a multiplicity of predetermined drilling positions. In the case of the represented exemplary embodiment, through-holes 7 with a circular cross section are to be produced. Alternatively to this, any other cross-sectional shapes, for example polygonal, oval or other shapes are possible for the through-holes 7.

Specifically, provision is made for altogether 15 drilling positions A to O on the upper wall 3 at which through-holes 7 are to be produced in the upper wall 3 of the component 1 by means of the laser beam 6. This can easily be seen in FIG. 2 which shows a schematic view of the drilling-position pattern. FIG. 2 shows a top view of the drilling-position pattern. This comprises 2 lines and 5 rows of drilling positions which generate a rectangular shape.

Using the method according to embodiments of the invention, through-holes 7 are introduced into the upper wall 3 of the component 1 by means of the laser beam 6 at all the drilling positions A to O. To this end, the process is as follows.

At a predetermined first drilling position A, which lies in the first row and the first line of the drilling-position pattern, a first through-hole 7 is introduced into the wall 3 of the component 1. To this end, the laser beam 6 is oriented onto the drilling position A and material is removed by laser radiation. There is then a jump to the right into the nearest line, that is to say the middle line, and also downward into the next but one row, that is to say the middle row, of the drilling-position pattern shown in FIG. 2 to the drilling position B in the center of the pattern. In FIG. 2, the corresponding jump from the drilling position A to the drilling position B is shown schematically by means of an arrow. When jumping from drilling position A to drilling position B, the two drilling positions nearest to the predetermined drilling position A, specifically the drilling positions J and N, and also the drilling position L which has a slightly greater distance to the drilling position A than the drilling positions J and N, are omitted, therefore not provided with through-holes 7. At the further drilling position B, which lies further away from the initial drilling position A than each of the three nearer-lying omitted drilling positions J, L and N, the second through-hole 7 is then introduced. The laser beam 6 is directed onto the drilling position B for this and drilling is carried out again in order to create a further through-hole 7 in the upper wall 3 of the component 1 at the drilling position B.

For the introduction of further through-holes at further drilling positions the aforesaid steps are carried out in multiple iterations.

Specifically, starting from the drilling position B which is provided with a through-hole 7, a jump is made into the next line and the next but one row to the drilling position C. A further through-hole 7 is introduced at the drilling position C. When jumping from drilling position B to drilling position C, all the drilling positions nearest to the drilling position B, that is to say the drilling positions L, G, D and K and also the drilling positions J, I, M and H, are omitted. Starting from the drilling position C as the initial drilling position, in a further iteration a jump is made into the middle row of the drilling-position pattern to the drilling position D. In this case, the drilling positions O, K and H which lie close to the drilling position C are omitted. The drilling position H which lies between the drilling position C and the drilling position D is also skipped in the process. A further through-hole 7 is then introduced at the drilling position D.

In the aforesaid manner, as indicated in FIG. 2 by the corresponding arrows, through-holes 7 are also produced by the laser beam 6 in the upper wall 3 of the component 1 at the remaining drilling positions by further repetitions of the previously described method steps.

In the sectional view in FIG. 1, the component is shown in a state in which through-holes 7 have already been produced at some, but not yet at all, of the drilling positions A to O. Specifically, two through-holes 7 are to be seen in the step.

As a result of the deliberate omitting or skipping of close-lying drilling positions when introducing two directly consecutive through-holes 7, the heat quantity, which is introduced into the wall 3 of the component 1 and also into the cavity 2 and therefore into the liquefiable protective agent 5 provided in this as a result of the multiplicity of laser drilling processes carried out one after the other, is distributed to regions which lie further apart. The protective agent 5 can therefore completely cool down in and around the region of a drilling position at which a through-hole 7 has just been produced before returning to a drilling position, which lies nearest to this, and a further through-hole 7 is introduced there. The local heating up of the protective agent 5 provided in the cavity 2 of the component 1 is consequently reduced. This is achieved by the energy input into the protective agent 5 per time unit or volume unit being reduced as a result of the deliberate omission of nearest drilling positions and/or as a result of the deliberate skipping of nearest drilling positions.

In this way, the effect of the protective agent 5 being locally heated up to a high degree as a result of the production of a plurality of through-holes 7 lying closely next to each other during the laser machining process is reliably prevented. The protective agent 5 is thereby not liquefied and therefore does not flow out of the cavity 2 either. As a result, the protective agent 5 is reliably available in the cavity 2 for protection of the rear-side wall 4 of the component 1 at all times when introducing the through-holes 7 into the upper wall 3.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-6. (canceled)

7. A method for producing through-holes by laser radiation in a wall of a component, which delimits a cavity in which provision is made for a protective agent which can liquefy under heat, comprising:
introducing through-holes consecutively into the wall of the component at a multiplicity of defined drilling positions,
producing two directly consecutive through-holes in a way that a through-hole is created at a predetermined drilling position and the next through-hole is created at a further drilling position which lies further away from the predetermined drilling position than at least two drilling positions, which are omitted, which lie close to the predetermined drilling positions, and/or
producing two directly consecutive through-holes in a way that a through-hole is created at a predetermined drilling position and the next through-hole is created at a further drilling position, wherein at least one drilling position, which is omitted, lies between the predetermined drilling position and the further drilling two or more drilling positions, which are omitted, lie between the predetermined drilling position and the further drilling position, in which the multiplicity of defined drilling positions comprise a plurality of rows and a plurality of lines of drilling positions, and in which two directly consecutively introduced through-holes lie in different rows and/or in different lines.

8. The method as claimed in claim 7, in which a plurality of rows and/or lines of omitted drilling positions lie in each case between two directly consecutively introduced through-holes.

9. The method as claimed in claim 7, in which in a predetermined pattern one or more nearest drilling positions and/or one or more nearest rows of drilling positions and/or one or more nearest lines of drilling positions are omitted in each case.

10. The method as claimed in claim 7, wherein the further drilling position lies at least 1.5 times, especially at least two times and preferably at least three times or at least five times further away from the predetermined drilling position than that omitted drilling position which lies nearest to the predetermined drilling position.

11. The method as claimed in claim 7, wherein as a protective agent a polymer in the liquid state is introduced by pouring or spraying or injecting, into the cavity before the multiplicity of through-holes are introduced into the wall of the component.
